(19) United States
(12) Patent Application Publication
(10) Pub. No.: US 2004/0158506 A1
(43) Pub. Date: Aug. 12, 2004

(54) Product and parts management system, data processing system, serial number management method, computer program product, and computer-readable medium

(76) Inventor: Volkmar Wille, Wien (AT)

Correspondence Address: LERNER AND GREENBERG, PA, P O BOX 2480, HOLLYWOOD, FL, 33022-2480, US

(21) Appl. No.: 10/454,520

(22) Filed: Jun. 4, 2003

(30) Foreign Application Priority Data
Feb. 6, 2003 (AT) A 189/2003

(51) Int. Cl. G06F 17/60

(52) U.S. Cl. 705/28

(57) ABSTRACT

Products and product parts and/or the serial numbers associated with the products and product parts are managed in a distributed system. The method and the data processing installation checks and assembles serial numbers of the product parts and of the product and stores them in a database. When products or product parts are removed from inventory or warehousing, the corresponding serial numbers are removed from the database or they are marked as having been issued. The distributed system includes a goods receipt module, a product assembly module, a disassembly module, and a goods issue module.

### BACKGROUND OF THE INVENTION

Field of the Invention

The invention lies in the data processing and inventory management fields. More specifically, the invention relates to a system and a data processing installation for managing products and product parts and/or the serial numbers associated with the products and product parts.

For a company with international operations, such as telecommunications companies, it is of essential importance that all incoming and outgoing products, as well as installed products or product parts and their serial numbers be recorded without omissions. This makes a significant contribution to the business processes, such as quality, billing, fraud, stock logistics or maintenance logistics. These involve a multiplicity of different serial numbers, such as those based on the standards IMEI, SIM card or in-house serial numbers for vouchers and the like.

Spares and accessories for products or installed devices have different serial numbers with different structures, checking rules and supplier-specific forms. That is to say the demands on serial-number management involve a high level of flexibility and adaptability to the existing business processes and involve definition of the material flow points at which the serial numbers need to be recorded.

In addition, there is the requirement of supplying external systems, such as for billing or for order picking computers and the like, with serial numbers in short cycle times.

The requirements of the various company software modules likewise need to be taken into account. Thus, by way of example, stock logistics, possibly with warehouse management, make demands which are different than those of maintenance logistics with the technical sites and items of equipment.

The recording of serial-number history, that is to say the development history associated with each serial number, needs to be ensured since it provides important data for other business processes, such as bonus, commission payments and investigation of fraud. This means that a relatively large volume of data needs to be provided within a very short time using web applications (Internet or intranet) as well.

### SUMMARY OF THE INVENTION

It is accordingly an object of the invention to provide a data processing, a product management system and process, as well as a computer product and data carrier which overcome the above-mentioned disadvantages of the heretofore-known devices and methods of this general type and which affords an improved system for managing the products and product parts with the aid of omission-free management using the unique identifiers (e.g., serial numbers) for these products and product parts.

With the foregoing and other objects in view there is provided, in accordance with the invention, a product management method for managing products, product parts, and identifiers (e.g., serial numbers) associated with the products and product parts, comprising:

checking received goods (delivered from a supplier) in a goods-receipt module (SNE-GR module) and storing identifiers (serial numbers) associated with the goods in a database;

assigning the identifiers to material master data and structure data for the identifiers, and storing the data in a database;

for products comprising product parts, recording with a disassembly module (SNE Disassembly) the identifiers (serial numbers) of the product parts and assigning the identifiers to a leading identifier (serial number) of the respective product and storing the identifiers in the database;

for products to be assembled, assigning with an assembly module (SNE-Assembly) the recorded identifiers (serial numbers) of the product parts to one another and logically combining the recorded identifiers with a leading identifier (serial number) for the product and storing in the database; and

upon delivery of a product or a product part to a customer, upon fitting a product part or installation of a product at an installation site, removing the corresponding identifiers (serial numbers) of the issued products from the database or marking the identifiers as having been issued with a goods issue module (SNE GI) connected to the database.

In prior art recording systems for serial numbers, omission-free recording and checking of the serial numbers or comparable numbers have been carried out only in special cases, such as in the pharmaceutical sector. Comparable such serial number management has not been known to date in other technical fields, such as in the telecommunications industry.

The novel system according to the invention may be summarized as follows:

a Goods-Receipt module (SNE-GR module) checks the goods delivered by the supplier and the serial numbers on said goods and stores them in a database,

the material master data are assigned serial numbers, possibly combinational logic for a plurality of serial numbers, and structure data for the serial numbers, and the data are stored in a database,

where, for products comprising product parts, an SNE Disassembly module records the serial numbers of the product parts and assigns them to the leading serial number of the product and stores them in the database,

or where, for products which are to be assembled,

in an SNE Assembly module the recorded serial numbers of the product parts are assigned to one another and are logically combined with a leading serial number for the product and are stored in the database,

and in that, upon delivery of the products to the customer or upon fitting of spares or installation of a product at an installation site, a Goods-issue module (SNE GI) removes the serial numbers of the issued products from the database or marks them as issued.

Omission-free serial-number management is advantageous for a high standard of quality in a company. It needs to meet the following requirements:

high level of flexibility

linking of external systems, e.g. order picking systems, billing

recording only at defined material flow points.

It affects the fundamental business processes, such as

goods receipt—stock logistics and maintenance

internal/external assembly

goods issue—delivery and maintenance

warranty and handling of repairs

data interchange—billing systems, order picking computers etc.

The core part, recording the serial number of incoming and outgoing goods and goods movements, is performed in an ERP transaction programmed in-house (such as SAP). Particular requirements are good performance on the basis of the time-critical character of the application and also ease of use.

Master data and movement data are both managed and recorded in ERP. Inter alia, online checking of the recorded serial numbers with the ERP dataset is possible. The serial-number recording transaction is the core of the application which flexibly provides functionalities such as list evaluations etc.

Within the context of an authorization concept, only the pure recording transaction will be available to the ordinary user. The management of recorded data, the creation of evaluations, the activation and deactivation of checks etc. will be possible under protection in a menu which is accessible only to administrators. In addition, the users are managed exclusively in the ERP standard transactions.

For serial-number management, master data are available which firstly describe the form of material and also the structure of a material's serial numbers unambiguously. Flexible checking routines including pattern identification for manufacturer's serial numbers are advantageous.

Rapid recording of serial numbers in Goods Receipt is a prerequisite for reducing process costs. It is supported by various tools, such as UN/Edifact, download files, serial-number ranges etc. Similarly supported is the external and the internal assembly process for products or devices from separate parts. Individual stipulation of the checking depth or checking stringency likewise reduces the process costs in this case by avoiding the use of additional quality modules.

In Goods Issue, a leading serial number is recorded, all the associated serial numbers are read for it from the database, and these serial numbers are stored back. The prerequisite of also using external requests, such as WEB applications, for clearly identifying the respective business case is thus met.

For maintenance logistics, the material master is managed with separate weighting in order to be able to take the financial guidelines as a basis for making the distinction between investment material, new material or faulty materials.

In addition, the material classification is used to assign these to the technical objects of the radio installation. The technical objects themselves are likewise classified in order to be able to make a distinction and to implement checking logic for the combination of material and installation site on an installation, e.g. push-in card/rack.

The goods-receipt process is similar to that for stock logistics. In addition, for maintenance, the appropriate pieces of equipment are generated and structured in the background.

For the rest of the business processes, it is possible to use a DRAG&DROP menu which assists the technicians when installing and removing the equipment and carries out the fundamental business management processes in the background.

The methods of serial-number management are used to define the processes along supply chain management on the basis of the serial numbers. The processes and methods are organized as follows:

Master Data:

Stipulation of the serial-number types and classes which clearly describe and define a technical product. Collation and assignment of the serial number into a serial-number list (BOS). Stipulation of the internal and external checking patterns.

By way of example, the checking logic comprises the following checking steps: check order, check duplicate serial numbers, check serial numbers already contained in the stock, check equipment already provided.

Definition:

Free definition of the serial-number types—this defines unique serial numbers such as, by way of example, SIM card, IMEI No, spare parts etc.

Free definition of the serial-number classes—this defines a plurality of serial numbers for a master serial number, such as packages, racks etc. and forms the basis of the serial-number list (BOS).

The serial-number list defines the serial-number structure of a material in a similar manner to the material list and depicts the checking logic for the serial numbers used.

Free definition of the checking logic—this defines the checking patterns, length, prefix and suffix of the serial numbers and of the supplier-specific instances.

The master data for the serial-number types, classes and serial-number list and also checking logic are stored in a database and are available for the subsequent processes.

Database: The SNE database makes all incoming or outgoing serial numbers and the paired serial numbers available with the corresponding ERP reference record and depicts the serial-number history and life cycle of a serial number. Defined interfaces ensure data interchange with other EDP systems.

Goods receipt: Acceptance of the serial numbers and checking as described under “Master Data” above.

Creation of the technical equipment with a program in the background, and program installation to a technical location and storage of the serial numbers with a reference record in a database.

Disassembly/assembly: Combination of separate components to form a material or separation into the separate components.

Checking of the serial-number list (BOS) as described under “Master Data” above; splitting a product into the separate components, checking the BOS as described above, distributing the value over the separate components. The serial numbers are stored with the ERP reference record in a database.

Goods issue: Recording the leading serial number, reading the serial numbers paired in the database, checking as described above and storage with the ERP reference record in a database, electronic data transfer to the customer.

Possibly handling of warranties/repairs.

Serial-number history: Storage of all serial-number transactions with the ERP reference record in a database.

Interface: The database provides interfaces which make the serial numbers available to other EDP systems online/offline.

Other features which are considered as characteristic for the invention are set forth in the appended claims.

Although the invention is illustrated and described herein as embodied in a Serial Number Management, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagram illustrating the product flow in a system according to the invention;

FIG. 2 is a diagram and a parallel flow chart illustrating the management of a parts list and serial number list;

FIG. 3 is a similar diagram redrawing the right-hand side of FIG. 2;

FIG. 4 is a tabular layout illustrating examples of checking the serial-number types (SN-Type);

FIG. 5 is a flow diagram illustrating paperwork lines in Goods Receipt, leading to invoicing;

FIG. 6 is a schematic diagram illustrating an overview of options for the electronic transmission of serial numbers;

FIG. 7 is a block diagram providing an overview of how the data are checked in the SN-Check module;

FIG. 8 is a block diagram showing the second part of the number check;

FIG. 8A is a similar block diagram charting SN-Relevance and the selection of material flow nodes relevant for the serial numbers;

FIG. 9 is a block diagram showing the management for spare parts in Goods Receipt;

FIG. 10 is a schematic illustrating an example to show the SNE-Assembly module of FIG. 1 in more detail;

FIG. 11 illustrates the Disassembly module, i.e., it practically describes the opposite path of FIG. 10;

FIG. 12 is a schematic showing the assembly of the serial numbers in the Goods-Issue area;

FIG. 13 is a schematic diagram showing the flow of data for the serial numbers via various means of transmission to the customer buying the goods (the reverse order in relation to Goods Receipt);

FIG. 14 is a block diagram showing the management for the life cycle of spares;

FIG. 15 is a table illustrating the organization of historical serial number management; and

FIG. 16 is a diagrammatic overview of the interplay between the serial-number database and the individual systems of the system hardware according to the invention.

### DESCRIPTION OF THE PREFERRED EMBODIMENTS

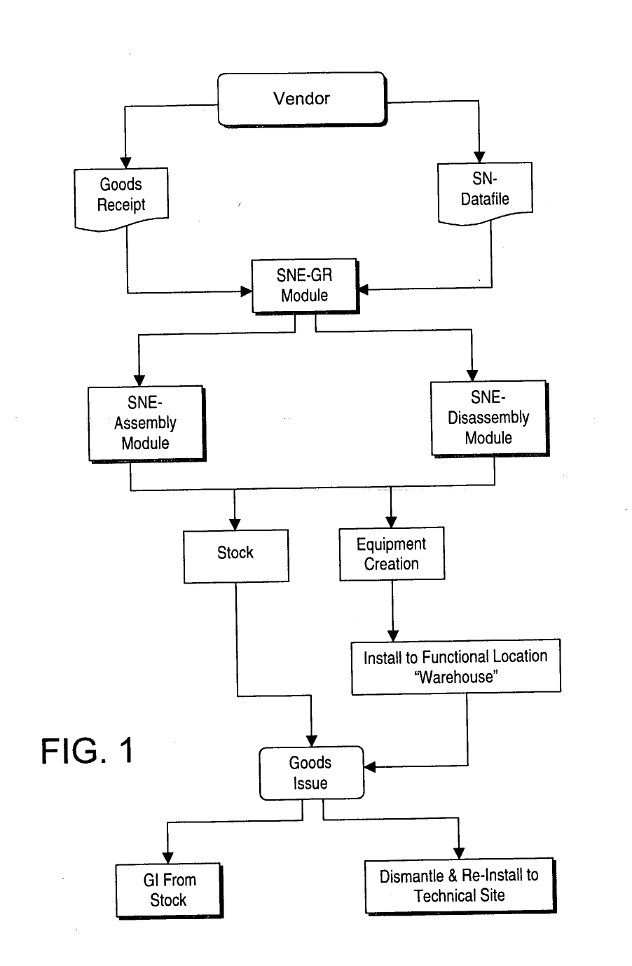

Referring now to the figures of the drawing in detail and first, particularly, to FIG. 1 thereof, there is shown an overview of the present management system for unique identification (ID) tags. While the invention will be described primarily with reference to a serial number management system, it will be understood that the invention covers all unique identification systems and the serial number management is to be understood as but an exemplary implementation of the invention.

The chart shows the flow of the products and of the serial numbers associated with these products through the company to the purchaser over time. The goods pass from the supplier through Goods Receipt to a goods-receipt module SNEGR module (Serial Number Entry Goods Receive module). Goods receipt can be accompanied by a serial-number datafile (SN datafile) which is additionally provided by the supplier.

In practice, the system according to the invention starts at actual goods receipt. The initial recording of the serial numbers is performed in the SNEGR module. The module allows the corresponding serial numbers to be assigned to the goods received and to be stored in a database. The data entered are actually checked upon entry and assignment.

By way of example, the checks are as follows:

whether the serial number already exists;

plausibility check;

correctness of the numbers or number-letter combination;

check to determine whether the serial numbers match the order, for example;

and all other checking options in this area.

In most cases, the product is passed on to inventory (warehouse stock).

A special feature in the telecommunications industry, but also in other sectors, is that the devices are made up of various supplied parts and can also be dismantled again. Two modules are provided for these steps, namely, an SNE-Assembly module and an SNE-Disassembly module.

In the SNE-Assembly module, the recorded serial numbers for the product parts (in the SNEGR module) are logically combined with a serial number for the product as leading serial number and are stored in a database. In principle, any of the serial numbers used can be provided as the leading serial number. Normally, the one used for this is the externally visible and hence controllable serial number, e.g. the mobile telephone's call number.

The SNE-Disassembly module is particularly useful for the area of repairs and for installation. The separate parts of assembled devices are recorded and stored together with their serial numbers, which can sometimes even require that the product be dismantled.

In a goods-issue module SNEGI module (Serial Number Goods Issue), delivery of the product involves the leading serial numbers being removed from the database or being marked as issued. At the same time, their logically combined serial numbers for the other components are also removed. The goods issue is passed to the purchaser (customer).

The flowchart of FIG. 1, which is labeled in relatively general terms, may be adapted particularly for technical installations, e.g. transmission towers and the like.

The warehouse (stock) contains the parts recorded previously as described above, or the database stores the more detailed hierarchical associations via the serial numbers.

A subbranch Equipment Creation allows the separate parts to be put into a particular hierarchy with respect to one another. By way of example, it is possible to check here that a piece of technical equipment from one company with five inserts is not assigned six pieces of equipment from another company as being insertible.

In the issuing module Goods Issue (GI), the assembled device is either installed, that is to say arranged as intended (left-hand branch GI from stock) or, in line with the right-hand branch, is removed from stock and is fitted at the installation site (e.g. in a network transmitter).

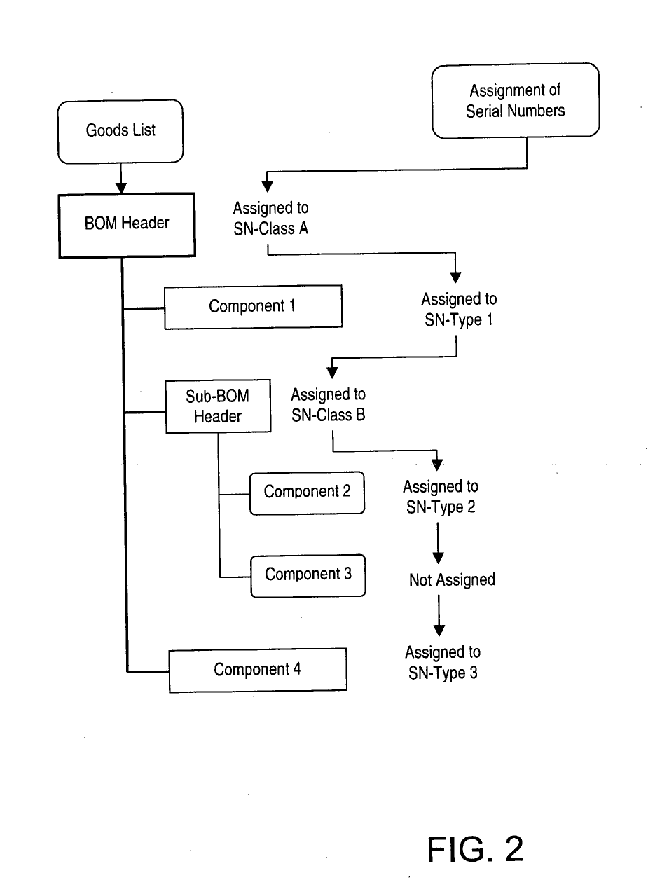

FIG. 2 shows the definition of the material parts lists/Bill Of Materials (BOMS) and illustrates an exemplary assignment of the serial numbers.

Normally, for fitting parts, there is a material parts list, as has been known heretofore in manufacturing technology. FIG. 2 shows a serial-number list in parallel therewith, where the respective components are assigned serial-number types (SN-Type 1, Type 2 etc.). It is also possible for further subsidiary parts lists (seen in terms of serial number) to be assigned. In FIG. 2, these are the middle sub-BOM headers, assigned to SN Class B. Assignment to types means that the part is assigned to one type of the serial number. By way of example, a number with a specific form is a telephone number, including the area code portion, the office code (or, exchange) portion, and the number portion. SN Class A is the serial-number parts list, while SN Class B is the subclass. The assignments are stipulated on the basis of software and on the basis of database.

Hence, the left-hand branch in FIG. 2 shows, as an example, a material parts list with the BOM header, a material component 1, a sub-BOM header with associated material components 2 and 3, and also with the material component 4. In line with the invention, these material parts lists are assigned to serial-number classes and to serial-number types in the right-hand column.

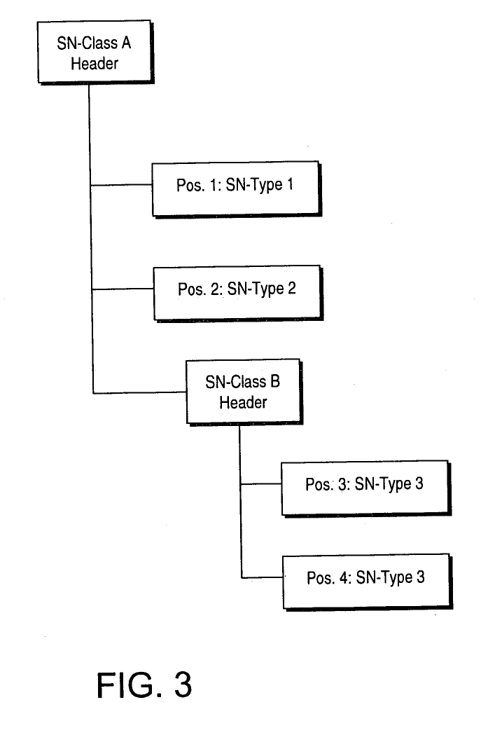

FIG. 3 illustrates the right-hand portion of FIG. 2 again, provided with the hierarchic assignment.

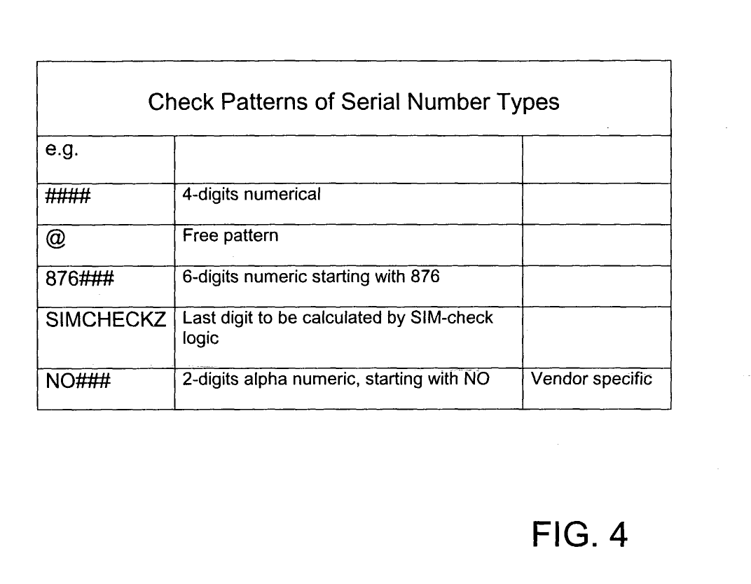

FIG. 4 shows examples of checking of the serial-number types (SN-Type). The checks usually proceed in two directions. First, the number itself is checked to determine whether it corresponds to the number type, whether it can be correct, etc. For this, there are checking patterns. In addition, the handling of this number is checked, e.g. duplicate allocation of the same number, etc.

The first row shows the check to determine whether the serial number comprises four digits. The symbol in the second row represents any character. The logic in row 3 checks whether the serial number is a 6-digit number starting with the digits 876. The acronym SIMCHECKZ is an instruction to check the number on the basis of checking logic for SIM card numbers. The last row checks for five alphanumeric characters starting with NO.

By way of example: Assume the product in question is a Motorola product with a unit number SWLN7137CB. It is known from the manufacturer that the preamble SWL represents a group of unit numbers. The unit is uniquely identified with the preamble SWL and the midamble N7137. The letters CB, in this case, are a trailing check identifiers with an internal meaning to Motorola, and they are entirely unimportant in the instant case.

Checking the serial number with regard to whether or not the product is one originating with the correct manufacturer is satisfied by simply checking the preamble, i.e., the letters SWL that are followed by further symbols, as indicated by the asterisk. The unambiguous association and assignment of the serial number to the noted manufacturing company (here, Motorola) is effected with reference to the databank independently of the serial number, since each supplier is assigned a supplier number which forms a part of the base data.

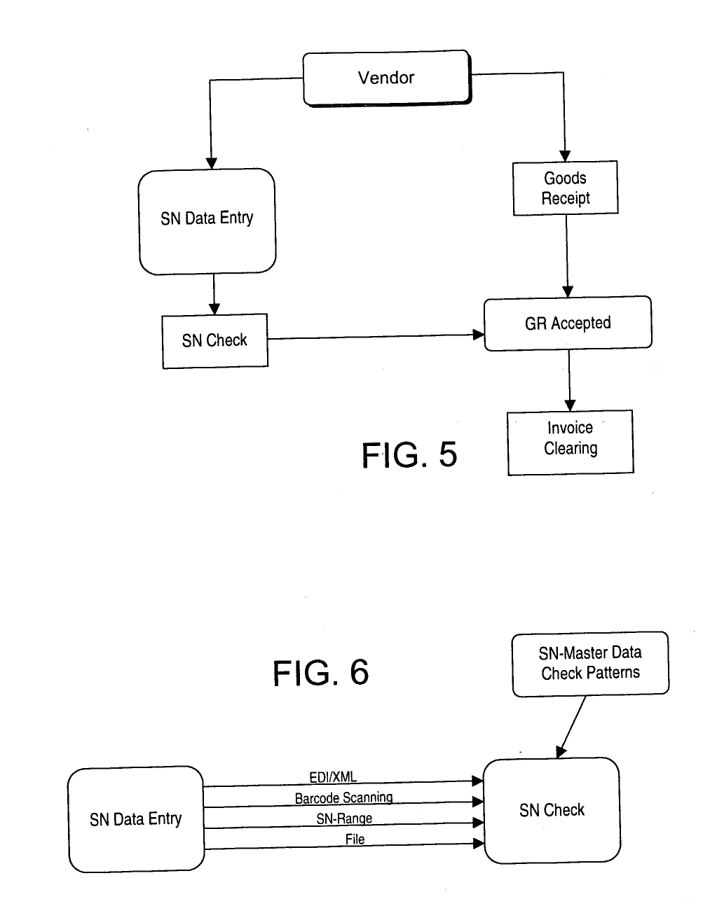

FIG. 5 shows the flow of paper in Goods Receipt as far as invoicing. It will be understood that the flow and processes may also be entirely or partly paperless.

The invoice is not cleared for payment until both goods receipt and entry of the serial numbers have passed through the checks and are found to be in order.

Advantageously, it has been found that the omission-free recording of the serial numbers in an SN Data Entry procedure means that the subsequent check by the SN check can provide clearance for the goods to be accepted in a database and provides clearance for the invoice.

FIG. 6 shows an overview of options for the electronic transmission of serial numbers. The double acronym EDI/XML represents Electronic Data Interchange based on the XML standard (extensible markup language). This can be, by way of example, file transfer over the Internet or any other electronic data interchange based on the XML standard. In line with the prior art, entry by means of bar code scanning is performed using hand-held devices such as wands, or stationary scanners. SN range means that not every serial number is entered independently, but rather that a serial number range is indicated for a delivery, with every part then being assigned the specific serial number within the system provided. The right-hand part of FIG. 6 shows that the transferred data are checked in the SN-Check module, specifically using the SN-Master Data Check Patterns, as are listed in FIG. 4, for example.

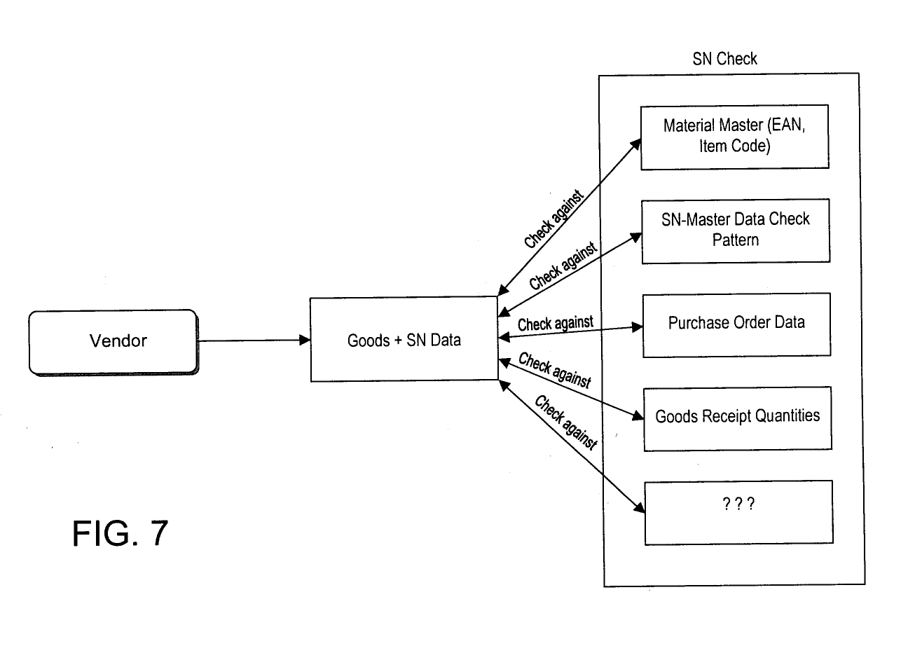

FIG. 7 shows an overview of how the data are checked in the SN-Check module. There is thus a check against the material master data, for instance by utilizing a regional code (such as EAN—European Article Number) or the manufacturers' article numbers (item code). In addition, the check described above is performed on the basis of the checking pattern shown in FIG. 4. In addition, the comparison with the order date (purchase order data) and whether the quantity of goods is correct is performed. Other checks are to be put in place on a case-by-case basis.

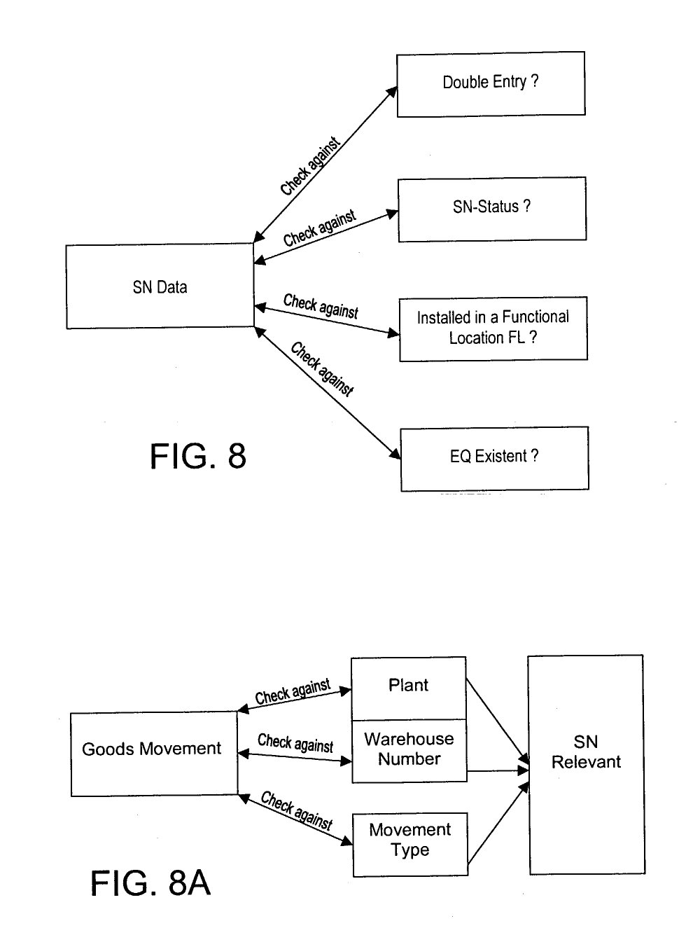

FIG. 8 shows the second part of the number check, namely the handling of the numbers. This involves a check to determine whether and how the serial number fits into the environment.

The check for double entry shows, by way of example, whether a number has been scanned in twice by mistake. The SN status shows, by way of example, whether the part with this number has already been delivered to a dealer, so that new entry of this part cannot be correct. In addition, it is possible to check whether the part has already been fitted in a transmission station, which is equivalent to a status check (in the “Installed in a Functional Location” FL module). As a further example, the check to determine whether the part already exists in the database (EQ existent) is shown.

The chart of FIG. 8A, which could be entitled SN-Relevance, shows a stipulation of the rules of play for the material flow points at which the various checks and entries are made. By way of example, it is necessary to prevent any movement of a part from bringing about a change in the database.

For checking in the top hierarchy, plant and warehouse number: there are, by way of example, production sites or warehouses whose goods are already held in the database and therefore do not need to be recorded again. By contrast, first deliveries or external parts need to be recorded without omission. The movement type checks that not every movement is recorded, such as, for instance, internal movements within the warehouse. It is necessary, however, to record, by way of example, movements of the goods from and to the factory or warehouse.

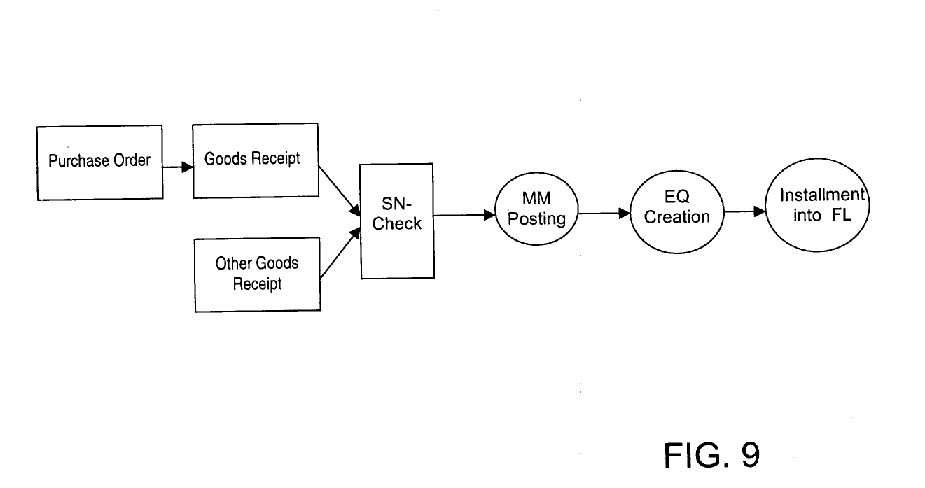

FIG. 9 shows the management for spare parts in Goods Receipt. The figure is thus related to the right-hand part of FIG. 1. The serial numbers are passed to the serial-number check (SN-Check) either via the order and Goods Receipt or via another Goods Receipt “Other Goods Receipt” (e.g. from a repair). Following the number check, MM-posting puts the goods received into stock. In the Equipment Creation module, the part is related to the hierarchic structure of the device which is to be installed or has been installed. The part is then installed at the installation site, that is into the functional location FL, which is recorded in a database.

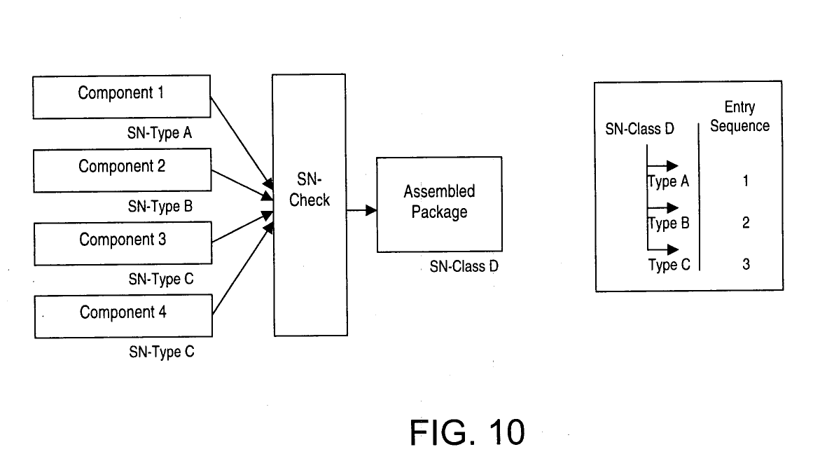

FIG. 10 uses an example to show the SNE-Assembly module from FIG. 1 in more detail. By way of example, four components with the serial number types A, B and C are assembled in a database following the SN-Check to produce the finished device (package). The device's serial number is from Class D. The right-hand side of FIG. 10 again shows that Class D comprises the types A, B and C. Types A, B and C also have the order of recording assigned to them.

The completely assembled package, therefore, does not receive a new identifier, but instead it is associated with a serial number list (SN-Class D). The list is assembled from individual serial number classes. During the assembly in the SNE-Assembly module, the (typically external) serial numbers of the components, such as SN-Type A, B, C, are checked and put together in a parts list that is associated with the completed package. The right-hand box of FIG. 10 shows the association between the SN-Class D of the package, i.e., the parts list, and the serial numbers of the individual components (SN-Types A, B, C).

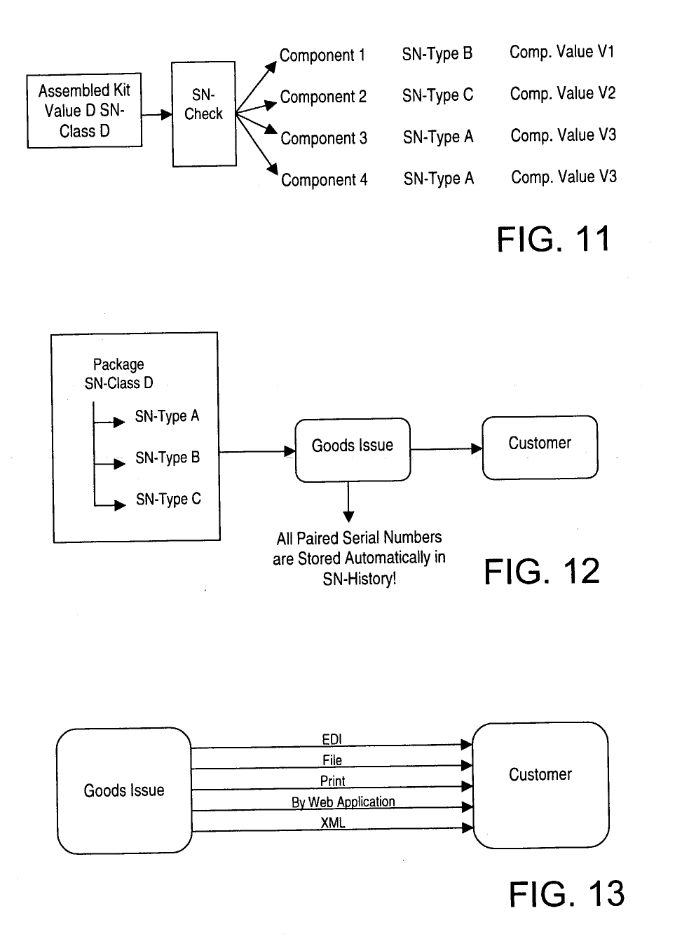

FIG. 11 then shows the Disassembly module and practically describes the opposite path of FIG. 10. Following splitting into the separate components with the various serial-number types A, B and C, the components are also assigned value sums V1, V2, V3 on a proportional basis, said value sums together being intended to come to the value of the assembled article. By way of example, this is necessary for internal stock assessment and the associated financial accounting.

FIG. 12 shows the assembly of the serial numbers in the Goods-issue area. One of the serial numbers is selected as the leading serial number, and only this number is recorded in Goods Issue. For all the serial numbers linked thereto, the serial-number history is automatically stored. In the left-hand field, the Bill of Serial Number once more appears, with the classes and subclasses of the serial number. See also FIG. 10 with the data for assembly.

FIG. 13 shows the flow of data for the serial numbers via various means of transmission to the customer buying the goods. This is in reverse order relative to the situation of data transfer in Goods Receipt.

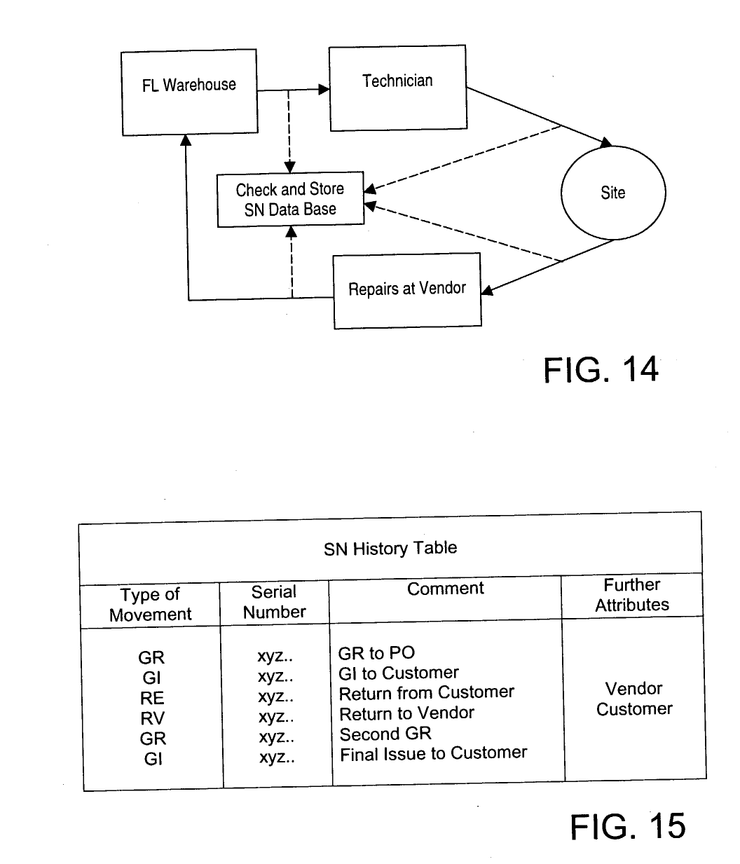

The diagram of FIG. 14 shows the management for the life cycle of spares. This relates to the transmitting stations, for example. A technician picks a spare from stock and takes it as a new part to the article which is to be repaired (site). There, the faulty part is replaced, removed and sent to the supplier as a repair order. The supplier puts the repaired part back into stock either as such a repaired part or as a new part.

All of these steps are checked and stored in the serial-number database. The check is made using the serial numbers, as for all other movements, and in addition the history is updated.

FIG. 15 shows a list of history records by way of example. The entries relating to the type of movement have already been described above in FIG. 8A.

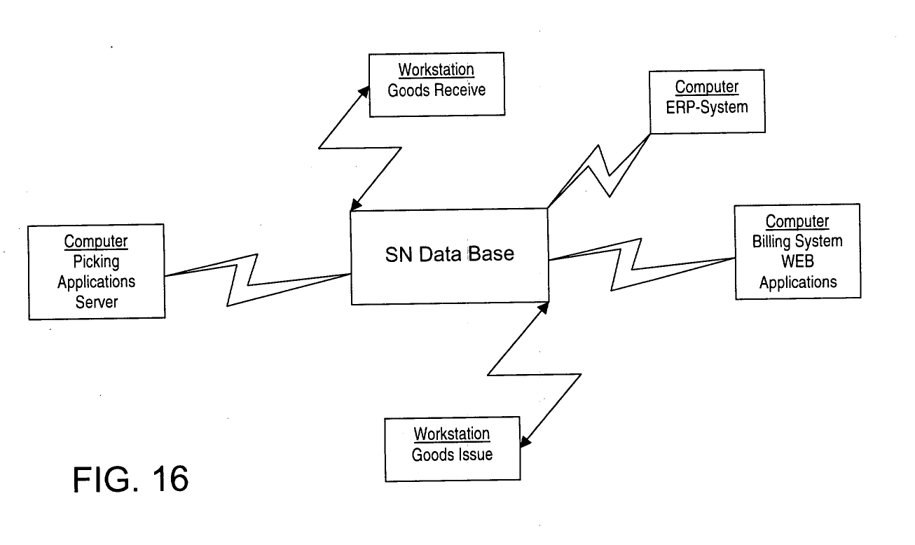

FIG. 16 shows an overview of the interplay between the serial-number database and the individual systems of the hardware. The data processing installation comprises at least one data input unit, a data output unit and at least one data store with a database. As illustrated, separate EDP units, albeit ones which access or form a common database, can be provided for the various input and output steps and processing procedures.

The invention has been described above with reference to a distributed hardware implementation utilizing serial number assignments as the unique identifiers of the products and product parts. It will be understood that a variety of alternative identifiers are equally possible for the realization of the invention (the terms identifier and serial number should be understood as interchangeable and in accordance with their broadest meaning). Further, it is also understood that the invention is implemented in a software system and it may be realized in a computer program product or a mixed software and hardware system. Data carriers are provided for that purpose, which include all computer-readable media such as, inter alia, any kind of computer memory device, floppy disks, hard disks, optical and magnetic devices, CD-ROMs, Flash ROMs, non-volatile and volatile ROMs and PROMs, RAM, as well as carrier waves of transmission signals, and the like.

I claim:

1. A product management method for managing products, product parts, and identifiers associated with the products and product parts, comprising:
checking received goods in a goods-receipt module and storing identifiers associated with the goods in a database;
assigning the identifiers to material master data and structure data for the identifiers, and storing the data in a database;
for products comprising product parts, recording with a disassembly module the identifiers of the product parts and assigning the identifiers to a leading identifier of the respective product and storing the identifiers in the database;
for products to be assembled, assigning with an assembly module the recorded identifiers of the product parts to one another and logically combining the recorded identifiers with a leading identifier for the product and storing in the database; and
upon delivery of a product or a product part to a customer, upon fitting a product part or installation of a product at an installation site, removing the corresponding identifiers of the issued products from the database or marking the identifiers as having been issued with a goods issue module connected to the database.

2. The method according to claim 1, wherein the identifiers are serial numbers of the products and product parts and the leading identifier is a leading serial number of a product.

3. The method according to claim 2, wherein the assigning step comprises combining a plurality of serial numbers with a combinatorial logic.

4. The method according to claim 2, which comprises subjecting the serial numbers, immediately upon or following input, to a respective predefined checking pattern, and storing the checked serial numbers in the database.

5. The method according to claim 2, which comprises assigning the serial numbers classes and subclasses in line with a chosen hierarchy.

6. The method according to claim 2, which comprises assigning the serial numbers classes and subclasses in line with a hierarchy prescribed by an association of the product parts.

7. The method according to claim 1, which comprises, for managing installed products and related product parts, logically combining the associated identifiers with one another, and, upon installation of the product, removing the product's identifier from the database or marking the product as installed, and, upon replacing a product parts in the form of a spare, producing a new logic combination for the identifier and removing the spare from the database or marking the spare as installed.

8. The method according to claim 2, wherein a life cycle of the serial numbers and of the products or product parts is managed without omission in a history-management module and storing the life cycle in a database.

9. The method according to claim 2, which comprises managing spares for installed devices by collating the serial numbers, following checking and placement in the stock of goods, in a database containing virtual products made up of product parts.

10. The method according to claim 9, which comprises collating the serial numbers with reference to hierarchic structures.

11. The method according to claim 9, which comprises collating the serial numbers in an equipment creation module.

12. The method according to claim 1, wherein the checking step comprises checking the identifiers in goods receipt by checking a structure of the identifier itself and checking based on a logic in a dataset in the database.

13. The method according to claim 1, which comprises assigning values to the product parts recorded in the disassembly module.

14. A data processing system, comprising:
at least one data input device, at least one data output device, and at least one data memory device with a database;
a goods-receipt module for checking goods delivered from a supplier and storing the serial numbers of the goods in the database, said goods-receipt module thereby managing the products, product parts, and/or the serial numbers associated with the products and product parts;
wherein the material master data are assigned serial numbers, optionally with combinational logic for a plurality of serial numbers, and structure data for the serial numbers, and the data are stored in the database;
a deassembly module for recording the serial numbers of product parts of products comprising product parts, and assigning the serial numbers to a leading serial number of the product and storing the serial numbers in the database;
an assembly module for assigning the serial numbers of the product parts to one another, linking with a leading serial number of the product, and storing in the database;
a goods issue module managing an outflow of products or product parts, said goods issue module, upon delivery of the products to a customer or upon fitting of spares or installation of a product at an installation site, removing the serial numbers of the issued products from the database or marking the serial numbers of the issued product as issued.

15. The data processing system according to claim 14 configured to implement the method according to claim 1.

16. A computerized product management system, comprising a plurality of modules commonly configured to perform the product management method according to claim 1.

17. The computerized product management system according to claim 16 and implemented as a hierarchical serial number management system.

18. A computer-readable medium having stored thereon computer-executable instructions for performing the product management method according to claim 1.

19. A product management system for managing products, product parts, or serial numbers associated with the products and product parts, comprising:
a database for storing serial numbers related to the products or product parts;
a goods-receipt module configured and programmed to checking goods delivered from a supplier and for storing the serial numbers associated with the goods;
an assembly module connected to said goods-receipt module, said assembly module being configured and programmed to record the serial numbers of the product parts, assigning the serial numbers to a leading serial number of the product, combining the parts into an assembled package, and storing the assembled package in said database;
a disassembly module connected to the database, said disassembly module being configured and programmed to disassemble the package and, optionally, to remove given product parts from the package and replace given product parts in the package; and
a goods issue module connected to said database, said goods issue module, upon delivery of the products to a customer or upon fitting of product parts or installation of a product at an installation site, removing the corresponding serial number of the issued product or product part from the database or marking the serial number as having been issued.

20. A computer-readable medium having stored thereon computer-executable instructions for implementing the product management system according to claim 19, the computer-executable instructions including software programs for each of said assembly module, said disassembly module, and said goods issue module.
